(19) United States
(12) Patent Application Publication
(10) Pub. No.: US 2024/0208349 A1
(43) Pub. Date: Jun. 27, 2024

(54) AUTOMATIC PARKING SYSTEM AND AUTOMATIC PARKING CONTROL DEVICE

(71) Applicant: TOYOTA JIDOSHA KABUSHIKI KAISHA, Toyota-shi (JP)

(72) Inventor: Yutaka TANAI, Numazu-shi (JP)

(73) Assignee: TOYOTA JIDOSHA KABUSHIKI KAISHA, Toyota-shi (JP)

(21) Appl. No.: 18/385,983

(22) Filed: Nov. 1, 2023

(30) Foreign Application Priority Data
Dec. 26, 2022 (JP) 2022-208907

(51) Int. Cl. B60L 53/36; B60L 53/30; B60L 53/37

(52) U.S. Cl. CPC B60L 53/36; B60L 53/305; B60L 53/37

(57) ABSTRACT

An automatic parking system includes: a vehicle and an automatic charger to supply power to the vehicle. Further, the automatic charger includes a sensor that detects a positional deviation amount between a parking position and target parking position of the vehicle, and a communication device to transmit the positional deviation amount to the vehicle, the vehicle includes a communication device to receive the positional deviation amount, and a control device to execute automatic parking control for automatically parking the vehicle in a parking space, and, when the automatic parking control starts, the control device causes the vehicle to automatically park in the target parking position in the parking space, corrects the target parking position based on the positional deviation amount obtained from the automatic charger, and executes the automatic parking control again so that the vehicle can park in the corrected target parking position.

### CROSS-REFERENCE TO RELATED APPLICATION (S)

The present application claims priority to and incorporates by reference the entire contents of Japanese Patent Application No. 2022-208907 filed in Japan on Dec. 26, 2022.

### BACKGROUND

The present disclosure relates to an automatic parking system and an automatic parking control device.

Japanese Laid-open Patent Publication No. 2016-141161 discloses an automatically parking of the vehicle in the parking space with respect to the vehicle stopped in the parking space, the non-contact charger installed in the parking space to transmit power in a non-contact, the charging the power to the battery of the vehicle. In the configuration described in Japanese Laid-open Patent Publication No. 2016-141161, when automatically parking the vehicle, based on the information of the sensor provided in the non-contact charger on the ground side, the efficiency of the non-contact charging guides the vehicle to the optimum position.

### SUMMARY

There is a need for providing an automatic parking system and an automatic parking control device that can improve the accuracy of the parking position when parking a vehicle automatically in a parking space without requiring enormous data capacity.

According to an embodiment, an automatic parking system includes: a vehicle capable of being charged by an external charger; and an automatic charger, installed in a parking space, that supplies power to a vehicle parked in the parking space, the automatic parking system causing the vehicle to automatically park in the parking space where the automatic charger is installed. Further, the automatic charger includes a sensor that detects a positional deviation amount between a parking position of the vehicle parked in the parking space and a target parking position of the vehicle parked in the parking space, and a first communication device that performs a wireless communication with the vehicle to be parked in the parking space, and transmit the positional deviation amount detected by the sensor to the vehicle, the vehicle includes a second communication device that performs a wireless communication with the automatic charger installed in the parking space to which the vehicle is to be parked, and receive the positional deviation amount transmitted from the first communication device, and a control device that executes automatic parking control for automatically parking the vehicle in the parking space, and the control device, when the automatic parking control starts, causes the vehicle to automatically park in the target parking position in the parking space, corrects the target parking position based on the positional deviation amount obtained from the automatic charger, and executes the automatic parking control again so that the vehicle can park in the corrected target parking position.

According to an embodiment, an automatic parking control device, mounted on a vehicle capable of being charged by an external charger, executes automatic parking control for automatically parking the vehicle in a parking space. Further, the automatic parking control device, in a case where, when the automatic parking control is executed, a positional deviation amount between a parking position of the vehicle and a target parking position is received from an automatic charger installed in the parking space by a wireless communication between the automatic charger and the vehicle, corrects the target parking position based on the positional deviation amount, and executes the automatic parking control again so that the vehicle can park in the corrected target parking position.

### BRIEF DESCRIPTION OF THE DRAWINGS

FIG. 1 is a diagram schematically illustrating an automatic parking system in the embodiment;

FIG. 2 is a flowchart for explaining the automatic parking control;

FIG. 3 is a diagram illustrating an example of a calculation process;

FIG. 4 is a diagram for explaining a sensor;

FIG. 5 is a diagram for explaining a connection mechanism; and

FIG. 6 is a diagram for explaining the three axes in the connection mechanism.

### DETAILED DESCRIPTION

In the configuration described in Japanese Laid-open Patent Publication No. 2016-141161, in order to improve the accuracy of the parking position, and stores the information indicating the corresponding relationship between the charging efficiency and the vehicle position in the storage unit of the vehicle side, automatic parking by using the information. However, since it requires enormous data capacity in the storage unit on the vehicle side to store the information, there is room for improvement.

Hereinafter, the automatic parking system and the automatic parking control device in the embodiment of the present disclosure will be specifically described. Note that the present disclosure is not limited to the embodiments described below.

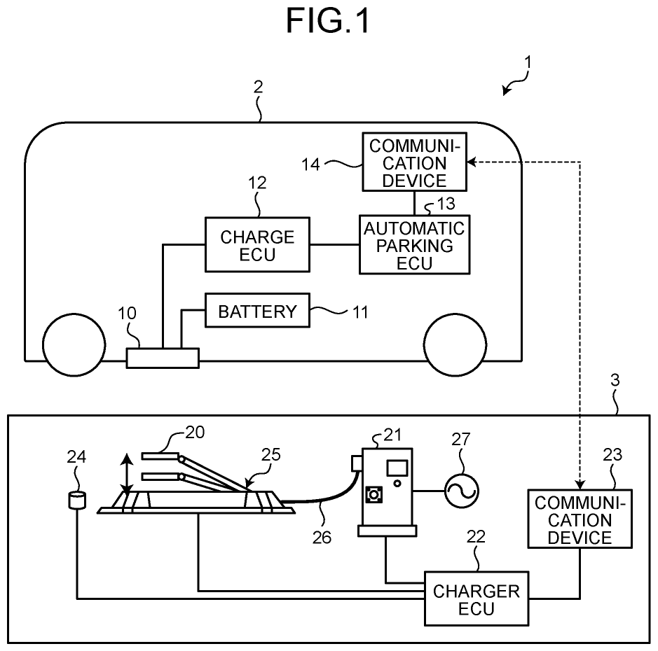

FIG. 1 is a diagram schematically illustrating an automatic parking system in the embodiment. An automatic parking system 1 includes a vehicle 2, an automatic charger 3. Automatic parking system 1 includes a system for automatically parking the vehicle 2 in a parking space in which the automatic charger 3 is provided, the automatic charger 3 is automatically connected to the vehicle 2 parked in the parking space and a system for supplying power (automatic charging system).

The vehicle 2 is an electric vehicle capable of charging power supplied from an external power source, for example, an electric vehicle (BEV) or plug-in hybrid vehicle (PHEV) and the like. The vehicle 2 is a vehicle capable of parking in a parking space in which the automatic charger 3 is installed. The vehicle 2 includes an inlet 10, a battery 11, a charge ECU 12, an automatic parking ECU 13, and a communication device 14.

The inlet 10 is a charging port and receives power supplied from an external power source. As illustrated in FIG. 1, the inlet 10 is provided at the bottom of the vehicle 2. The inlet 10 charging connector 20 of the automatic charger 3 is connected. With the charging connector 20 inserted (connected) to the inlet 10, the vehicle 2 can receive power supplied from the automatic charger 3. Then, the vehicle 2 supplies the power received from the automatic charger 3 from the inlet 10 to the battery 11. The inlet 10 and the battery 11 are electrically connected.

The battery 11 is an in-vehicle battery that can be externally charged. The battery 11 is a secondary battery capable of storing power supplied from the inlet 10. The battery 11 is constituted by, for example, a lithium ion battery. The battery 11 stores power supplied from an external power source connected via the inlet 10. The battery 11 also supplies power to the traveling motor of the vehicle 2. A running motor is electrically connected to the battery 11.

The charge ECU 12 is an electronic control device for executing a charging control for executing a charging control for storing electric power received by the inlet 10 in the battery 11. The electronic controller includes a processor and a memory (main storage unit). The processor is composed of a Central Processing Unit (CPU). The memory consists of a Random Access Memory (RAM) and a Read Only Memory (ROM). The signals from various sensors mounted on the vehicle 2 are inputted to the charge ECU 12. The charge ECU 12 executes the charging control based on the inputted from the various sensors.

The automatic parking ECU 13 is an electronic control device for executing an automatic parking control for automatically parking the vehicle 2 in the parking space. The Automatic parking ECU 13 is configured in the same manner as the charge ECU 12 as the hardware configuration. The automatic parking ECU 13 executes automatic parking control based on signals inputted from various sensors mounted on the vehicle 2 and information obtained by communication using the communication device 14.

The communication device 14 performs wireless communication with external devices. The communication device 14 performs a wireless communication with the communication device 23 of the automatic charger 3. The communication device 14 transmits a signal from the vehicle 2 to the automatic charger 3 and receives a signal transmitted from the automatic charger 3 to the vehicle 2. The communication device 14, when the vehicle 2 is to park in the parking space, receives a radio signal as short-range wireless communication transmitted from the automatic charger 3 installed in the parking space. That is, the communication device 14 includes a short-range communication device that enables short-range wireless communication and a far-range communication device that enables far-range wireless communication. The communication device 14 may be expressed as a communication device or a second communication device on the vehicle 2 side.

The automatic charger 3 is installed in the parking space, a facility for supplying power to the vehicle 2 by automatically connecting the charging connector 20 to the vehicle 2 that has been parked completed in the parking space. The automatic charger 3 comprises a charging connector 20, a power supply stand 21, a charger ECU 22, a communication device 23, and a sensor 24.

The charging connector 20 is a connector that is automatically connected to the inlet 10. The charging connector 20 is coupled to a connecting mechanism 25. Charging connector 20 and the connecting mechanism 25 is installed on the ground of the parking space. The coupling 25 is controlled by a charger ECU 22. The charging connector 20 may be automatically repositioned by a connecting mechanism 25. The charging connector 20 is electrically connected to the power supply stand 21 via a charging cable 26.

The power supply stand 21 is installed near the parking space. The power supply stand 21 is connected to the AC power source 27. The AC power source 27 is a power source for supplying power to the charging connector 20, for example, a commercial power source or a home power source. The power from the AC power source 27 is supplied to the charging connector 20. The power supply stand 21 supplies power from the AC power source 27, via a charging cable 26 to the charging connector 20. The power supply stand 21 has a power conversion unit for converting the AC power supplied from the AC power source 27 into transmission power to output to the charging connector 20. The power converter is controlled by a charger ECU 22.

The charger ECU 22 is an electronic controller which controls the power supply stand 21, the communication device 23 and the connecting mechanisms 25.

The charger ECU 22 is configured similarly to the charge ECU 12 as a hardware-based configuration. The charger ECU 22 executes various controls based on signals inputted from various sensors provided in the automatic charger 3 and information acquired through communication using the communication device 23. For example, the charger ECU 22 controls the switching elements included in the power converter to adjust the power for power transmission.

The communication device 23 performs wireless communication with the vehicle 2 to be parked in the parking space. The communication device 23 transmits information from the charger ECU 22 to the vehicle 2 and receives information transmitted from the vehicle 2. The communication device 23 is capable of wireless communication by, for example, Wi-Fi (registered trademark) or a wireless LAN. The communication device 23 transmits a radio signal as a short-range wireless communication targeting the vehicle 2 to be parked in the parking space. That is, the communication device 23 includes a short-range communication device that enables short-range wireless communication and a long-range communication device that enables far-range wireless communication. The communication device 23 may be expressed as a ground-side communication device or a first communication device.

In such an automatic parking system 1 configured, it is possible to automatically park the vehicle 2 in the parking space. When the vehicle 2 is to park the parking pace automatic charger 3 is installed, the vehicle 2 establishes a wireless communication with the automatic charger 3. That is, the vehicle 2, before the communication of the wired connection charging connector 20 is inserted into the inlet 10, it is possible to communicate with the automatic charger 3 by wireless communication using the communication device 14 of the vehicle 2 side.

Then, in a state where the vehicle 2 is parked completed in the parking space where the automatic charger 3 is installed, it is possible to perform external charging by automatically inserting the charging connector 20 into the inlet 10. In the automatic parking system 1, for establishing a wireless communication between the vehicle 2 and the automatic charger 3 when performing automatic parking, the vehicle 2 is a wireless communication between the automatic charger 3 before the parking is completed is established. That is, before the wired communication is established by inserting the charging connector 20 into the inlet 10, the vehicle 2 and the automatic charger 3 can transmit and receive information by wireless communication. Therefore, in a state where wireless communication between the vehicle 2 and the automatic charger 3 is established, the charging connector 20 is automatically connected to the inlet 10 power supply from the automatic charger 3 to the vehicle 2 is performed. In the vehicle 2 is controlled to supply the power received by the inlet 10 to the battery 11.

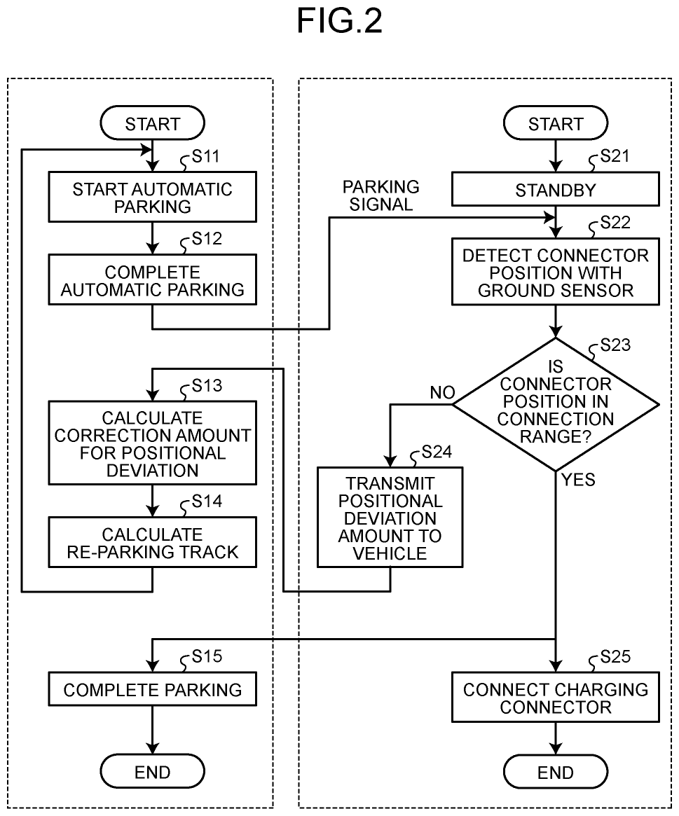

FIG. 2 is a flowchart for explaining the automatic parking control. The control illustrated in FIG. 2 is executed by the vehicle 2 and the automatic charger 3.

The vehicle 2 starts automatic parking to the parking space (step S11). In step S11, the automatic parking ECU 13 starts automatic parking control. When the automatic parking ECU 13 starts automatic parking control, the automatic parking ECU 13 controls the driving device and the steering device and the braking device of the vehicle 2 so as to park the vehicle 2 in a predetermined target parking position of the parking space. The target parking position is set at a predetermined position in the parking space to be parked. The automatic parking ECU 13 can set the target parking position.

The vehicle 2 completes the automatic parking to the parking space (step S12). In step S12, it means that the vehicle 2 is automatically parked in the target parking position. The automatic parking ECU 13 can determine whether the vehicle 2 is located at the target parking position based on images captured by cameras mounted on the vehicle 2 or on the detection result by a radar mounted on the vehicle 2. Therefore, the automatic parking ECU 13, when it is determined that the vehicle 2 is located at the target parking position, completes the automatic parking to the parking space. Then, the automatic parking ECU 13 transmits a parking signal indicating that the vehicle 2 is parked in the target parking position to the automatic charger 3.

The automatic charger 3 is in standby status (step S21). In the automatic charger 3 in the standby state, it is possible to receive by the communication device 23. For example, the automatic charger 3 may shift to the standby state when detecting the vehicle 2 to be parked in the parking space. In this case, by the sensor 24 detects the vehicle 2, the automatic charger 3 shifts to the standby state. This standby state is also referred to as the power supply ready state.

When the standby automatic charger 3 receives the parking signal from the vehicle 2, the sensor 24 detects the connector position of the vehicle 2 (step S22). In step S22, the position of the inlet 10 is detected by the sensor 24. The sensor 24 detects the positional deviation amount of the position of the inlet 10 with respect to the position of the charging connector 20. In short, the sensor 24 detects the positional deviation amount of the parking position of the vehicle 2 with respect to the target parking position. For example, the target parking position is set to a range in which the inlet 10 is located within the range capable of connecting the charging connector 20.

The automatic charger 3 determines whether the inlet 10 is located within the scope to which the charging connector 20 can be connected (step S23). In step S23, it is determined whether the inlet 10 is located within the scope to which the charge connector 20 can be connected. The charger ECU 22, upon receiving the parking signal, based on the signal inputted from the sensor 24, determines whether the inlet 10 is located within the connectable range of the charging connector 20.

As a result of the determination process of step S23, when it is determined that the inlet 10 is not positioned within the range capable of connecting the charging connector 20 (step S23: No), the automatic charger 3 transmits the positional deviation amount of the inlet 10 with respect to the charging connector 20 to the vehicle 2 (step S24). In step S24, the information including the positional deviation amount is transmitted from the communication device 23.

The vehicle 2, after transmitting the parking signal by the process of the step S12, upon receiving the information indicating the positional deviation amount from the automatic charger 3, calculates a correction amount for the positional deviation (step S13). In step S13, the corrected amount of the target parking position is calculated based on the positional deviation amount acquired from the automatic charger 3. The auto parking ECU 13 corrects the target parking position using this correcting quantity. That is, the target parking position is reset to the target parking position after correction, such as to eliminate the positional deviation.

Further, the vehicle 2 calculates the parking track when the vehicle 2 is automatically parked again in the parking space (S14 steps). In step S14, the re-parking track is calculated such that the vehicle 2 is parked in the target parking position after the compensation. Then, the automatic parking ECU 13 automatically parks the vehicle 2 to the target parking position after correcting. Therefore, when the process of the step S14 is performed, the control routine returns to the step S11.

As a result of the determination process of step S23, when it is determined that the inlet 10 is located within the range capable of connecting the charging connector 20 (step S23: Yes), the automatic charger 3 automatically connects the charging connector 20 to the inlet 10 (step S25). In step S25, the charger ECU 22 actuates the connecting mechanisms 25, adjusting the position of the charging connector 20, and automatically inserting the charging connector 20 into the inlet 10. When the process of step S25 is performed, the control routine of the automatic charger 3 ends.

In addition, when it is determined that the inlet 10 is located within the range where the charging connector 20 can be connected (step S23: Yes), the automatic charger 3 transmits a completion signal indicating that the inlet 10 is located within the connection range of the charging connector 20 to the vehicle 2.

The vehicle 2, upon receiving the completion signal from the automatic charger 3, completes the parking to the parking space (step S15). In step S15, the automatic parking control is terminated. The automatic parking ECU 13, when receiving a completion signal after transmitting the parking signal, terminates the automatic parking control by determining that the vehicle 2 is parked in the target parking position. When the process of step S15 is performed, the control routine of the vehicle-2-side ends.

Thus, the automatic parking ECU 13, after transmitting the parking signal, only when obtaining the positional deviation amount from the automatic charger 3, corrects the target parking position based on the positional deviation amount, the vehicle 2 to the target parking position after correcting automatically parking again.

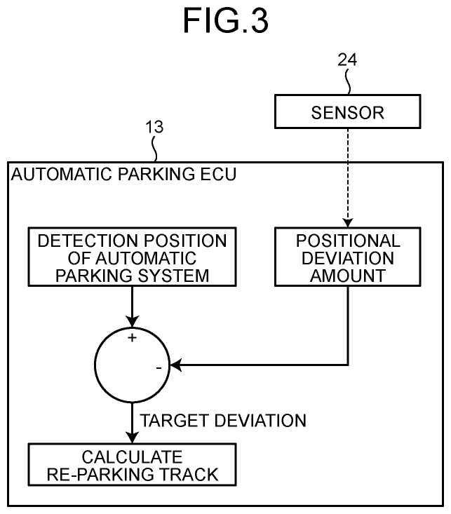

FIG. 3 is a diagram showing an example of calculation processing. The automatic parking ECU 13 calculates a deviation between the target parking position in the automatic parking control and the position deviation detected by the sensor 24. The automatic parking ECU 13 sets the calculated deviation as the target deviation and calculates the parking track when the automatic parking again based on the target deviation. The target deviation is, for example, the target parking position after correction.

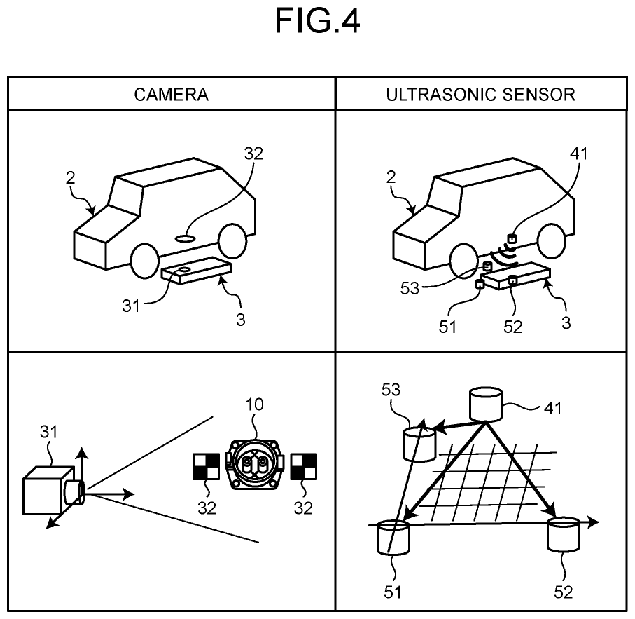

FIG. 4 is a diagram for explaining the sensor. As illustrated in FIG. 4, the sensor 24 may be configured by a camera or an ultrasonic sensor.

If the sensor 24 is a camera, the automatic charger 3 has a camera 31. The camera 31 is installed on the ground in the parking space, to image the upper in the vertical direction. A marker 32 is provided around the inlet 10 in the vehicle 2. The camera 31 images the inlet 10 including a marker 32 disposed around the inlet 10. The camera 31 outputs the captured image-data to the charger ECU 22. The charger ECU 22 image-processes the image data captured by the camera 31 to calculate the position of the inlet 10.

If the sensor 24 is an ultrasonic sensor, the vehicle 2 has an ultrasonic transmitter 41 and the automatic charger 3 has three ultrasonic receivers 51, 52 and 53. Three ultrasonic receivers 51, 52, 53 are installed on the ground to receive ultrasonic waves transmitted from the ultrasonic transmitter 41 on the vehicle 2 side. When the three ultrasonic receivers 51, 52, and 53 on the ground side receive ultrasonic waves, the charger ECU 22 calculates the position of the inlet 10 based on the distances between the three ultrasonic receivers 51, 52, and 53 on the ground side and the ultrasonic transmitter 41 on the vehicle 2 side.

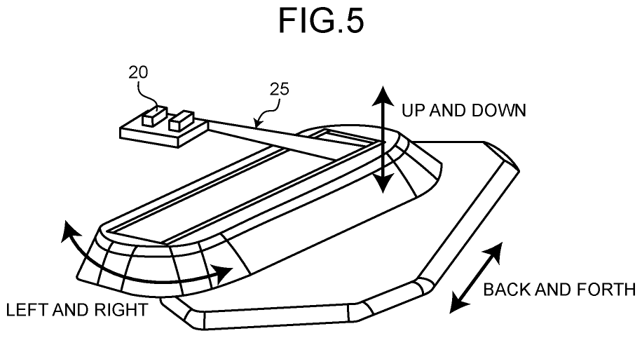

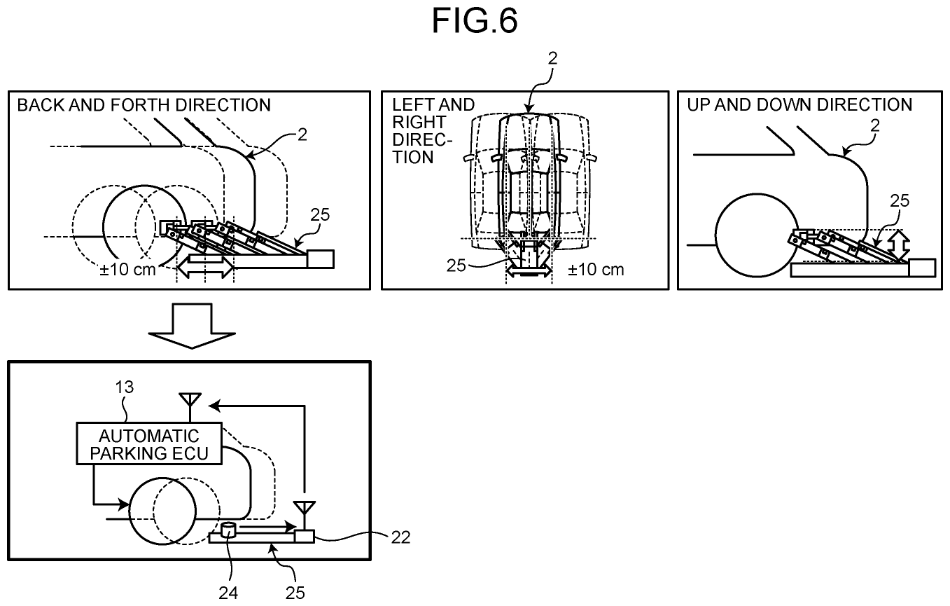

FIG. 5 is a diagram for explaining a connection mechanism. The connecting mechanism 25, in three axes including the front-rear axis and the left-right axis and the vertical axis, is configured to be able to change the position of the charging connector 20 structure. The connecting mechanisms 25, as illustrated in FIG. 6, has a connection range of ±10 cm in the longitudinal direction from the reference position by the front-rear shaft. Further, the connecting mechanism 25 has a connection scope of ±10 cm in the lateral direction from the reference position by the left and right axes. This reference position is common between the front-rear axis and the left-right axis. The charger ECU 22 can set this reference position to the target parking position.

As described above, according to the embodiment, the vehicle 2 using the position deviation amount detected by the sensor 24 of the automatic charger 3 corrects the target parking position, it is possible to perform the automatic parking again to the parking space. Thus, it is possible to improve the accuracy of the parking position when automatically parking the vehicle 2 in the parking space.

Incidentally, the inlet 10 is not limited to the bottom of the vehicle 2, may be provided such as on the side or top of the vehicle 2. In short, the position at which the inlet 10 is provided is not particularly limited.

The automatic charger 3 is not limited to a charger having a charging connector 20 may be a non-contact charger. When the automatic charger 3 is a non-contact charger, the vehicle 2 is provided with a power receiving device including a power receiving coil. Then, the sensor 24 detects the position of the power receiving coil installed at the bottom of the vehicle 2.

In the present disclosure, when the vehicle is automatically parked in the parking space, providing the information detected by the sensor included in the automatic charger to the vehicle, it is possible to perform the automatic parking again to the parking space by correcting the parking position in the vehicle side. Thus, without requiring enormous data capacity, it is possible to improve the accuracy of the parking position when automatically parking the vehicle in the parking space.

According to an embodiment, when parking the vehicle to the target parking position of the parking space, to correct the target parking position based on the positional deviation amount acquired from the automatic charger, it is possible to perform the automatic parking again. Thus, without requiring enormous data capacity, it is possible to improve the accuracy of the parking position when automatically parking the vehicle in the parking space.

According to an embodiment, the vehicle only when obtaining the positional deviation amount from the automatic charger after transmitting the parking signal, it is sufficient to perform the automatic parking again by correcting the parking position.

According to an embodiment, the vehicle only when obtaining the positional deviation amount from the automatic charger during execution of the automatic parking control corrects the target parking position based on the positional deviation amount, it is sufficient to automatically park again to the target parking position after correction.

According to an embodiment, the vehicle only when obtaining the positional deviation amount from the automatic charger after transmitting the parking signal, it is sufficient to perform the automatic parking again by correcting the parking position.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An automatic parking system comprising:
a vehicle capable of being charged by an external charger; and
an automatic charger, installed in a parking space, configured to supply power to a vehicle parked in the parking space, the automatic parking system being configured to cause the vehicle to automatically park in the parking space where the automatic charger is installed, wherein
the automatic charger includes
a sensor that detects a positional deviation amount between a parking position of the vehicle parked in the parking space and a target parking position of the vehicle parked in the parking space, and
a first communication device configured to perform a wireless communication with the vehicle to be parked in the parking space, and transmit the positional deviation amount detected by the sensor to the vehicle,
the vehicle includes
a second communication device configured to perform a wireless communication with the automatic charger installed in the parking space to which the vehicle is to be parked, and receive the positional deviation amount transmitted from the first communication device, and
a control device configured to execute automatic parking control for automatically parking the vehicle in the parking space, and
the control device is configured to, when the automatic parking control starts,
cause the vehicle to automatically park in the target parking position in the parking space,
correct the target parking position based on the positional deviation amount obtained from the automatic charger, and
execute the automatic parking control again so that the vehicle can park in the corrected target parking position.

2. The automatic parking system according to claim 1, wherein the control device is configured to,
transmit a parking signal indicating that the vehicle is parked in the target parking position after the automatic parking control is started,
correct the target parking position and execute the automatic parking control again so that the vehicle can park in the corrected target parking position when the positional deviation amount is received from the automatic charger after the parking signal is transmitted, and
complete parking in the parking space when the positional deviation amount is not received from the automatic charger after the parking signal is transmitted.

3. The automatic parking system according to claim 1, wherein
the vehicle includes an inlet,
the automatic charger includes a charging connector to be connected to the inlet and a connection mechanism, connected to the charging connector, that automatically changes a position of the charging connector so as to automatically connect the charging connector with the inlet, and
the target parking position is set to a range in which the inlet is located within a range where the charging connector is connectable with the inlet.

4. An automatic parking control device, mounted on a vehicle capable of being charged by an external charger, configured to execute automatic parking control for automatically parking the vehicle in a parking space, wherein the automatic parking control device is configured to, in a case where, when the automatic parking control is executed, a positional deviation amount between a parking position of the vehicle and a target parking position is received from an automatic charger installed in the parking space by a wireless communication between the automatic charger and the vehicle, correct the target parking position based on the positional deviation amount, and execute the automatic parking control again so that the vehicle can park in the corrected target parking position.

5. The automatic parking control device according to claim 4, wherein the automatic parking control device is configured to
transmit a parking signal indicating that the vehicle is parked in the target parking position after the automatic parking control is started,
correct the target parking position and execute the automatic parking control again so that the vehicle can park in the corrected target parking position when the positional deviation amount is received from the automatic charger after the parking signal is transmitted, and
complete parking in the parking space when the positional deviation amount is not received from the automatic charger after the parking signal is transmitted.
